(19) United States
(12) Patent Application Publication
(10) Pub. No.: US 2022/0076256 A1
(43) Pub. Date: Mar. 10, 2022

(54) METHOD AND SYSTEM FOR MONETIZATION OF FRACTIONAL SEGMENTS OF AN ASSET

(71) Applicant: Christopher Charles Anderson, West Sussex (GB)

(72) Inventor: Christopher Charles Anderson, West Sussex (GB)

(21) Appl. No.: 17/464,331

(22) Filed: Sep. 1, 2021

(30) Foreign Application Priority Data
Sep. 9, 2020 (IN) 202011038835

(51) Int. Cl. G06Q 20/40; G06Q 20/38

(52) U.S. Cl. CPC G06Q 20/401; G06Q 2220/00; G06Q 20/3821

(57) ABSTRACT

A method and system for monetization of fractional segments of an asset is disclosed. The method includes a step of recording a primary ownership and initializing a digitized master asset of the asset. The method also includes a step of creating multiple fractional segments of the digitized master asset and generating multiple cryptographic digital tokens. Further, the method includes a step of associating the fractional segments with the cryptographic digital tokens respectively. Furthermore, the method also includes a step of recording a secondary ownership of the fractional segments and the associated cryptographic digital tokens respectively. In addition, the method includes a step of facilitating a buy-back transaction of the fractional segments and the associated cryptographic digital tokens. The system includes one or more elements configured to perform the steps of the method.

### FIELD

The present disclosure relates in general to the field of online transaction of tangible and/or intangible assets and more particularly, to a method and system for monetization of fractional segments of the tangible and/or intangible assets.

### BACKGROUND

In recent times, individuals and businesses rely on online platforms, such as ecommerce websites, to sell tangible and/or intangible assets or products, such as digital or physical artwork, books, and music, to potential customers. Often, an asset, such as an artwork, is listed for a specific monetary value and sold to a customer who purchases the asset by paying the specific monetary value. Alternatively, the asset may also be auctioned and sold to the customer whose monetary bid has been accepted to acquire the asset.

However, prior to the sale of the asset, the individuals or businesses may need to raise capital in order to create or fund a development of the asset and/or establish a monetary valuation of the asset. Typically, the individuals or businesses seek help from investors interested in the asset in order to raise the capital. The investors may invest in the asset in exchange for a collateral or equity offered by the individuals or businesses.

The individuals or businesses may, however, may wish to pledge or sell fractional segments of the asset to the investors in order to raise the capital. In addition, the individuals or businesses may also wish to buy-back the fractional segments of the asset from the investors when the asset in entirety is to be sold to a third-party buyer interested in the asset.

### SUMMARY

The embodiments of the present disclosure described herein provide a method and a system for monetization of fractional segments of an asset.

An example of a method includes a step of recording a primary ownership of the asset. The asset may be a tangible or an intangible asset. The method also includes a step of initializing a digitized master asset of the asset. Further, the method includes a step of creating fractional segments of the digitized master asset. The method also includes a step of generating multiple cryptographic digital tokens equivalent to a count of the plurality of fractional segments created. Further, the method includes a step of associating the fractional segments with respective cryptographic digital tokens generated. In addition, the method includes a step of recording a secondary ownership of the plurality of fractional segments and the associated cryptographic digital tokens respectively. The secondary ownership may define a monetary value of the associated cryptographic digital tokens respectively. The method also includes a step of facilitating a buy-back transaction of the fractional segments and the associated cryptographic digital tokens based on the primary ownership and the secondary ownership recorded.

An example of a system includes a at least one transaction server including a digital ledger, wherein the at least one transaction server includes a communication bus, a memory to store predefined computer instructions, and a processor coupled with the communication bus. The processor may be capable of executing the predefined computer instructions in order to perform different functions. Further, the processor may include different computer modules to perform the functions. For example, the processor may include a registration module to record a primary ownership of the asset. The asset may be a tangible or an intangible asset. The processor may also include an initialization module to initialize a digitized master asset of the asset. Further, the processor may include a fractional segmentation module to create fractional segments of the digitized master asset. The fractional segmentation module may also generate multiple cryptographic digital tokens equivalent to a count of the plurality of fractional segments created. The fractional segmentation module may also associate the fractional segments with respective cryptographic digital tokens. Furthermore, the processor may include a fractional ownership module to record a secondary ownership of the plurality of fractional segments and the associated cryptographic digital tokens respectively. The secondary ownership may define a monetary value of the associated cryptographic digital tokens respectively. In addition, the processor may include a transaction module to facilitate a buy-back transaction of the fractional segments and the associated cryptographic digital tokens based on the primary ownership and the secondary ownership recorded.

### BRIEF DESCRIPTION OF DRAWINGS

FIG. 1 is a schematic block diagram of a system including a transaction server, in accordance with an embodiment of the present disclosure;

FIG. 2 is a schematic block diagram of the transaction server of FIG. 1 including a processor with different computer modules, in accordance to the embodiment of the present disclosure;

FIG. 3 is an exemplary illustration of an artwork that corresponds to an asset, in accordance with the embodiment of the present disclosure;

FIG. 4 is a schematic block diagram of the system of FIG. 1 including multiple transaction servers of the transaction server of FIG. 2 interconnected via blockchain networks, in accordance to another embodiment of the present disclosure; and

FIG. 5 is a flowchart of a method for monetization of fractional segments of the asset of FIG. 3, in accordance with the embodiment of the present disclosure.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts.

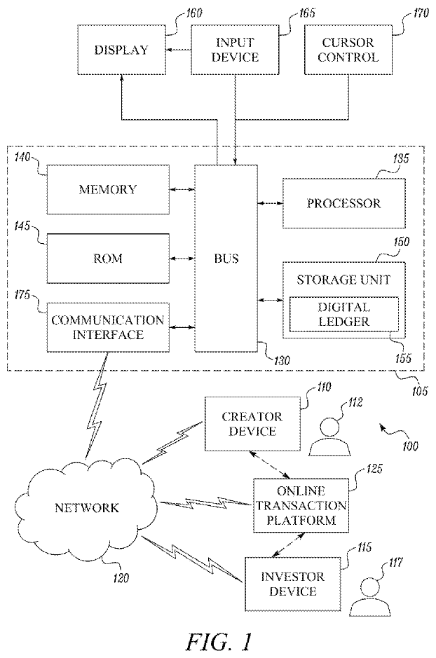

Referring to FIG. 1, a schematic block diagram of a system 100 including a transaction server 105 is disclosed. The transaction server 105 is herein referred to as “node 105”. The system 100 also includes electronic devices, for example, a creator device 110 of a creator 112 and an investor device 115 of an investor 117 in communication with the node 105 via a network 120. Examples of the electronic devices include, but are not limited to, computers, laptops, mobile devices, handheld devices, personal digital assistants (PDAs), tablet personal computers, digital notebook, and similar electronic devices. The network 120 may include communication networks such as, but not limited to, a Local Area Network (LAN), a Wireless Local Area Network (WLAN), a Wide Area Network (WAN), internet and a Small Area Network (SAN). The node 105 may also provide an online transaction platform 125, to facilitate online transactions between the creator 112 and the investor 117 via the creator device 110 and the investor device 115 respectively. The online transaction platform 125 may be provided as a stand-alone application and/or a web application on the creator device 110 and the investor device 115 respectively. In an embodiment, the network 120 may facilitate private and secure online transactions, commonly referred to as “peer-to-peer” transactions, between the creator device 110 and the investor device 115 via the online transaction platform 125. Examples of the online transactions include, but are not limited to, sale and/or transfer of digital assets such as media files, cryptocurrency, cryptographic tokens, currency, and digital smart contracts.

The node 105 includes a bus 130 or other communication mechanism for communicating information, and a processor 135 coupled with the bus 130 for processing information. The node 105 also includes a memory 140, such as a random-access memory (RAM) or other dynamic storage device, coupled to the bus 130 for storing information and instructions to be executed by the processor 135. The memory 140 can be used for storing temporary variables or other intermediate information during execution of instructions to be executed by the processor 135. The node 105 further includes a read only memory (ROM) 145 or other static storage device coupled to bus 130 for storing static information and instructions for processor 135. A storage unit 150, such as a magnetic disk or optical disk, is provided and coupled to the bus 130. The storage unit 150 may also include a digital ledger 155 for storing timestamped records of online transactions between the creator 112 and the investor 117 on the online transaction platform 125 provided by the node 105. In some embodiments, the node 105 may store the timestamped records of the online transactions in the digital ledger 155 corresponding to one or more actions performed by the creator 112 using the creator device 110 and/or the investor 117 using the investor device 115. Examples of the actions include, but are not limited, creating a digital smart contract, uploading digital assets, and offering services or products for sale. The timestamped records may include information such as, but not limited to, date and time of the creation of the digital smart contract, date and time of updates made to the digital smart contract, name of the creator 112 and/or the investor 117 involved in the digital smart contract, financial details corresponding to the digital smart contract, payment made by the investor 117, and date and time of payments made by the investor 117 and/or received by the creator 112.

In some embodiments, the node 105 may assign unique numeric or alphanumeric hash values corresponding the timestamped records in order to track and uniquely identify the timestamped records. The node 105 may also encrypt the timestamped records of the online transactions prior to storing the timestamped records in the digital ledger 155 respectively. The node 105 may employ different encryption methods, such as, for example, Advanced Encryption Standard (AES), Triple Data Encryption Standard (3DES), Pretty Good Privacy (PGP), Twofish, Ron Rivest, Adi Shamir and Len Adelman (RSA). For purposes of clarity and understanding, the RSA encryption method will be considered in the present disclosure. The RSA method involves use of cryptographic keys to store the timestamped records in the digital ledger 155 and/or share the timestamped records between the node 105 via the network 120. The cryptographic keys may include public keys, private keys, or a combination of both public and private keys, the combination referred to as a “key-pair”. The cryptographic keys or key-pairs may be used to keep the stored timestamped records digitally locked for security and privacy. The seller and/or the buyer may also share the cryptographic keys or key pairs with each other privately in order to decrypt and view the stored timestamped records using the cryptographic keys or key-pairs. In some embodiments, the cryptographic keys or key pairs may also uniquely identify the timestamped records in the digital ledger 155.

The node 105 can be coupled via the bus 130 to a display 160, such as a cathode ray tube (CRT), and liquid crystal display (LCD) for displaying information to a user. An input display 165, including alphanumeric and other keys, is coupled to bus 130 for communicating information and command selections to the processor 135. Another type of user input device is a cursor control 170, such as a mouse, a trackball, or cursor direction keys for communicating direction information and command selections to the processor 135 and for controlling cursor movement on the display 160. The input display 165 can also be included in the display 160, for example a touch screen.

Various embodiments are related to the use of node 105 for implementing the techniques described herein. In one embodiment, the techniques are performed by the node 105 in response to the processor 135 executing instructions included in the memory 140. Such instructions can be read into the memory 140 from another machine-readable medium, such as the storage unit 150. Execution of the instructions included in the memory 140 causes the processor 135 to perform the process steps described herein.

The term “machine-readable medium” as used herein refers to any medium that participates in providing data that causes a machine to operate in a specific fashion. In an embodiment implemented using the node 105, various machine-readable medium is involved, for example, in providing instructions to the processor 135 for execution. The machine-readable medium can be a storage media. Storage media includes both non-volatile media and volatile media. Non-volatile media includes, for example, optical or magnetic disks, such as storage unit 150. Volatile media includes dynamic memory, such as the memory 140. All such media must be tangible to enable the instructions carried by the media to be detected by a physical mechanism that reads the instructions into a machine.

Common forms of machine-readable medium include, for example, a floppy disk, a flexible disk, hard disk, magnetic tape, or any other magnetic medium, a CD-ROM, any other optical medium, punch cards, paper-tape, any other physical medium with patterns of holes, a RAM, a PROM, and EPROM, a FLASH-EPROM, any other memory chip or cartridge.

In another embodiment, the machine-readable medium can be a transmission media including coaxial cables, copper wire and fibre optics, including the wires that comprise the bus 130. Transmission media can also take the form of acoustic or light waves, such as those generated during radio-wave and infra-red data communications. Examples of machine-readable medium may include but are not limited to a carrier wave as describer hereinafter or any other medium from which the node 105 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the node 105 can receive the data on the telephone line and use an infra-red transmitter to convert the data to an infra-red signal. An infra-red detector can receive the data carried in the infra-red signal and appropriate circuitry can place the data on the bus 130. The bus 130 carries the data to the memory 140, from which the processor 135 retrieves and executes the instructions. The instructions received by the memory 140 can optionally be stored on storage unit 150 either before or after execution by the processor 135. All such media must be tangible to enable the instructions carried by the media to be detected by a physical mechanism that reads the instructions into a machine.

The node 105 also includes a communication interface 175 coupled to the bus 130. The communication interface 175 provides a two-way data communication coupling to the network 120. For example, the communication interface 175 can be an integrated service digital network (ISDN) card or a modem to provide a data communication connection to a corresponding type of telephone line. As another example, the communication interface 175 can be a local area network (LAN) card to provide a data communication connection to a compatible LAN. Wireless links can also be implemented. In any such implementation, the communication interface 175 sends and receives electrical, electromagnetic or optical signals that carry digital data streams representing various types of information.

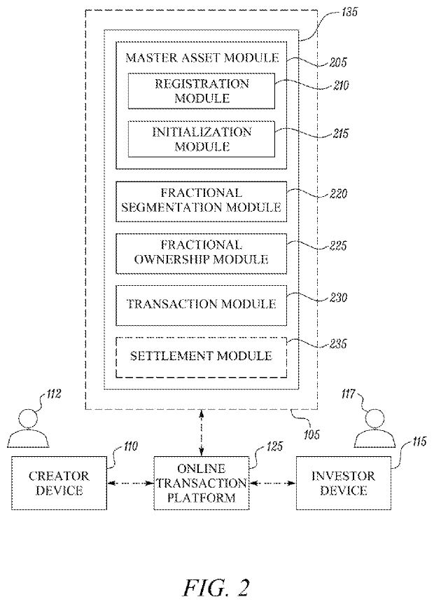

In some embodiments, the processor 135 of the node 105 may be capable of executing the one or more predefined computer instructions in order to perform one or more functions. Referring to FIG. 2, the processor 135 may also include one or more computer modules 205-235 to perform the one or more functions. The processor 135 may include a master asset module 205 having a registration module 210 and an initialization module 215. The processor 135 may also include a fractional segmentation module 220, a fractional ownership module 225, a transaction module 230, and a settlement module 235. The computer modules 205-235, may correspond to hardware circuitry and/or software programs configured to perform the one or more functions of the processor 135.

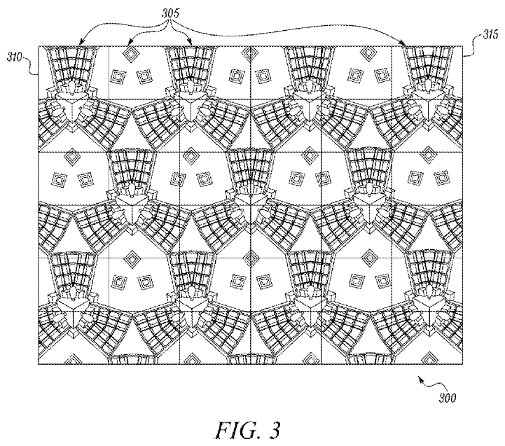

The registration module 210 may record a primary ownership of an asset such as, an artwork 300 (as shown in FIG. 3), a book, or music in the digital ledger 155 included in the storage unit 150 of the node 105. The creator 112, such as an artist, an author, or a musician, may hold the primary ownership of the asset. The primary ownership may correspond to a primary control and ownership of the asset. In an embodiment, multiple creators may hold the primary ownership of the asset. In one embodiment, the registration module 210 may record the primary ownership upon receiving a request from the creator 112 or the multiple creators of the asset via the online transaction platform 125. In another embodiment, the registration module 210 may record the primary ownership of the asset upon manual and/or direct addition of the primary ownership in the digital ledger 155. The asset may be a tangible asset, such as a physical art on canvas of the artwork 300, or an intangible asset, such as a digital image of the artwork 300. The record of the primary ownership in the digital ledger 155 may include encrypted metadata related to, but not limited to, a name of the creator 112 or names of the multiple creators of the asset, type of the asset, content of the asset, description of the asset, and a timestamp of recording the primary ownership of the asset.

The initialization module 215 may initialize a digitized master asset of the asset. In an embodiment, the initialization module 215 may receive and/or record a digital image or an electronic document of the asset provided by the creator 112 via the online transaction platform 125. The digital image or the electronic document may be received in various electronic formats. Examples of the electronic formats include, but not limited to, raster formats, vector formats, compound formats, stereo formats, audio formats, and electronic document formats. Subsequently, the initialization module 215 may initialize the digital image recorded as the digitized master asset. Further, the digitized master asset may have an associated digital electronic file. In another embodiment, the initialization module 215 may receive and/or record a digital image upon manual storage of the digital image in the storage unit 150 of the node 105. The initialization module 215 may then initialize the manually stored digital image as the digitized master asset.

In an embodiment, the initialization module 215 may then store the initialised digital master asset in the storage unit 150 and also store a timestamped record of the digitized master asset in the digital ledger 155. The timestamped record may include encrypted metadata related to, but not limited to, a static or dynamic link to retrieve the digitized master asset stored, a timestamp of the recording the asset and the initialization of the digitized master asset, and additional metadata associated with the digitized master asset.

The fractional segmentation module 220 may create multiple fractional segments of the digitized master asset. In an embodiment, the fractional segmentation module 220 may create multiple fractional segments of the digitized master asset based on, but not limited to, a visual segmentation, a logical or semantic segmentation, and/or an electronic document segmentation of the digitized master asset. In one embodiment, the creator 112 may define a specific number of the fractional segments of the digitized master asset to be created via the online transaction platform 125. In another embodiment, the fractional segmentation module 220 may create a predefined number of the fractional segments of the digitized master asset. For example, referring to FIG. 3, the digitized master asset may correspond to a digital image of the artwork 300. Accordingly, the fractional segmentation module 220 may create the multiple fractional segments by splitting the digital image of the artwork 300 into multiple visual portions 305 as defined by the creator 112 or as predefined. In one embodiment, the multiple visual portions 305 created by the fractional segmentation module 220 may have equal areas with respect to each other. For example, the visual portions 310 and 315 created by the fractional segmentation module 220 may have equal length and width with respect to each other and may hence have equal areas with respect to each other. In another embodiment, the multiple visual portions 305 created by the fractional segmentation module 220 may have unequal areas with respect to each other. For example, the visual portions 310 and 315 created by the fractional segmentation module 220 may have different lengths and widths with respect to each other and may hence have unequal areas with respect to each other. The multiple fractional segments created by the thereby by the fractional segmentation module 220 may correspond to multiple digital image files that include the multiple visual portions 305 respectively. For example, the visual portions 310 and 315 may be stored as two separate digital image files respectively.

In another example, the digitized master asset may correspond to an electronic book (not shown) that is commonly referred to as an “eBook”. Accordingly, the fractional segmentation module 220 may create the multiple fractional segments by segregating the eBook into multiple electronic documents as defined by the creator 112 or as predefined. In an embodiment, a count of the multiple electronic documents created may be equivalent to a count of chapters in the eBook. The multiple fractional segments created may therefore correspond to the multiple electronic documents of the eBook. Each electronic document created may include an individual chapter of the eBook.

In another example, the digitized master asset may correspond to an electronic book (not shown) that is commonly referred to as an “eBook”. Accordingly, the fractional segmentation module 220 may create the multiple fractional segments by segregating the eBook into multiple electronic documents as defined by the creator 112 or as predefined. In an embodiment, a count of the multiple electronic documents created may be equivalent to a count of chapters in the eBook. The multiple fractional segments created may therefore correspond to the multiple electronic documents of the eBook. Each electronic document created may include an individual chapter of the eBook.

In yet another example, the digitized master asset may correspond to digital music (not shown). Accordingly, the fractional segmentation module 220 may create the multiple fractional segments by splitting a digital music file associated with the digital music into multiple digital music files including different portions or compositions of the digital music respectively.

In an embodiment, the fractional segmentation module 220 may assign unique segment identifiers to the multiple fractional segments created respectively. Further, in one embodiment, the fractional segmentation module 220 may store the fractional segments created in the storage unit 150 of the node 105. In another embodiment, the fractional segmentation module 220 may store the fractional segments in one or more external servers (not shown) via the network 120 (see FIG. 1). The fractional segmentation module 220 may also store a timestamped record of the fractional segments created in the digital ledger 155. The timestamped record may include encrypted metadata related to, but not limited to, static or dynamic links to retrieve the fractional segments stored, the count of the fractional segments, and the unique segment identifiers associated with the fractional segments.

Referring again to FIG. 2, the fractional ownership module 225 may generate multiple cryptographic digital tokens equivalent to the count of the multiple fractional segments created. In one embodiment, the fractional ownership module 225 may generate the multiple cryptographic digital tokens automatically subsequent to the multiple fractional segments created. The fractional ownership module 225 may then associate the multiple fractional segments created with respective cryptographic digital tokens generated. In an embodiment, the fractional ownership module 225 may also assign a predefined monetary value to each cryptographic digital token generated. In one embodiment, the predefined monetary value may be specified by the creator 112 via the online transaction platform 125. In another embodiment, the monetary value may be automatically initialized to the predefined monetary value by the fractional ownership module 225. In yet another embodiment, the fractional ownership module 225 may not assign the predefined monetary value to the cryptographic digital tokens generated. In an embodiment, the fractional ownership module 225 may store the cryptographic tokens generated in a digital wallet owned by the creator 112 on the online transaction platform 125. The creator 112 may then proceed to sell the fractional segments and the associated cryptographic digital tokens to one or more investors such as, the investor 117 by creating a digital smart contract via the online transaction platform 125. The creator 112 may sell the fractional segments for a contract monetary value of the fractional segments respectively upon online negotiation and mutual agreement with the investors. In an embodiment, the contract monetary value may be lesser, equivalent to, or greater than the predefined monetary value of the cryptographic digital tokens respectively. In an embodiment, the fractional segmentation module 220 may monitor the sale of each fractional segment of the multiple fractional segments by the creator 112 to the investors. The fractional segmentation module 220 may then provide the confirmation of the sale to the fractional ownership module 225.

In another embodiment, the fractional ownership module 225 may generate the multiple cryptographic digital tokens upon confirmation of a sale of the multiple fractional segments created from the creator 112 to one or more investors, such as, the investor 117 via the online transaction platform 125. In an embodiment, the fractional segmentation module 220 may monitor the sale of each fractional segment of the multiple fractional segments by the creator 112 to the investors. The creator 112 may sell the fractional segments to the investors for the contract monetary value by creating a digital smart contract via the online transaction platform 125 after online negotiation and mutual agreement with the investors. The fractional segmentation module 220 may then provide the confirmation of the sale to the fractional ownership module 225. The fractional ownership module 225 may also associate each fractional segment with the respective cryptographic digital token generated as a result of the sale.

The fractional ownership module 225 may then record a secondary ownership by the investors of the multiple fractional segments and the associated cryptographic digital tokens respectively upon confirmation of the sale. The secondary ownership may correspond to a secondary control and ownership of the fractional segments. The fractional ownership module 225 may also associate the contract monetary value of the fractional segments, as defined by the secondary ownership, to the associated cryptographic digital tokens respectively. In an embodiment, the fractional ownership module 225 may then transfer the cryptographic digital tokens associated with the fractional segments to respective digital wallets owned by the investors based on the secondary ownership recorded.

For example, the fractional ownership module 225 may generate a cryptographic token corresponding to visual portion 310 (see FIG. 3) of the artwork 300. The cryptographic token generated by the fractional ownership module 225 may have a predefined monetary value of X or zero. The creator 112 may then proceed to sell the digital image file of the visual portion 310 (see FIG. 3), or a thumbnail of the visual portion 310, to the investor 117 via negotiations and mutual agreement on the online transaction platform 125 for a contract monetary value Y. The fractional segmentation module 220 may monitor and provide confirmation of the sale of the visual portion 310 of the artwork 300 to the fractional ownership module 225. The fractional ownership module 225 may then record the secondary ownership by the investor 117 of the visual portion 310. The fractional ownership module 225 may also associate the contract monetary value Y to the cryptographic token generated. The fractional ownership module 225 may then transfer the cryptographic token with the associated contract monetary value to a digital wallet owned by the investor 117 on the online transaction platform 125.

The fractional ownership module 225 may then store a timestamped record of the cryptographic digital tokens generated in the digital ledger 155. The timestamped record may include encrypted metadata related to, but not limited to, the cryptographic digital tokens associated with fractional segments, the sale of the fractional segments, the secondary ownership of the fractional segments, and digital addresses of digital accounts or wallets of the investors. In an embodiment, the fractional ownership module 225 may also generate a master digital ledger (not shown) from the timestamped record. The master digital ledger may include encrypted metadata related to, but not limited to, the primary ownership, the secondary ownership, the fractional segments and the associated cryptographic digital tokens.

In some embodiments, the fractional ownership module 225 may also facilitate a change in the secondary ownership of the fractional segments respectively. For example, the investor 117 may sell the fractional segment, such as the digitized visual portion 310 by creating a digital smart contract via the online transaction platform 125 to another investor (not shown). Accordingly, the fractional ownership module 225 may also store a timestamped record of the change in the secondary ownership in the digital ledger 155 and the master ledger respectively.

The transaction module 230 may facilitate a buy-back transaction of the fractional segments and the associated cryptographic digital tokens based on the primary ownership and the secondary ownership recorded. The transaction module 230 may facilitate the buy-back transaction for instances when the creator 112 may wish to auction and/or sell the artwork 300 in entirety to a third-party buyer of the artwork 300. In order to execute the buy-back transaction, the transaction module 230 may transfer the fractional segments and the associated cryptographic digital tokens from the secondary ownership to the primary ownership. For example, the transaction module 230 may facilitate a transfer of the fractional segments and the associated cryptographic digital tokens from the digital wallets of the investors to the digital wallet of the creator 112 respectively. In one embodiment, the transaction module 230 may also facilitate a transfer of ownership of the fractional segments from the investors such as investor 117, back to the creator 112 in order to complete the buy-back transaction. In another embodiment, the transaction module 230 may retain the secondary ownership of the fractional segments by the investors and execute only the transfer of the fractional segments and the associated cryptographic digital tokens to the creator 112. The transaction module 230 may also store a timestamped record of the buy-back transaction in the digital ledger 155. The timestamped record may include encrypted metadata related to, but not limited to, ownership, fractional segments, and the cryptographic digital tokens transferred. The transaction module 230 may also update the master digital ledger generated by the fractional ownership module 225 based on the timestamped record stored by the transaction module 230.

In an embodiment, the transaction module 230 may also generate a master token from the cryptographic digital tokens transferred. The master token may have a monetary value equivalent to a sum of the contract monetary value of the cryptographic digital tokens respectively. The transaction module 230 may also store a timestamped record of the master token generated in the digital ledger 155 and the master digital ledger respectively.

The transaction module 230 may also facilitate a sales transaction of the digitized master asset and the master token generated to the third-party buyer. For example, the creator 112 may sell the digitized master asset to the third-party buyer by creating a digital smart contract via the online transaction platform 125. Upon confirmation of the sale by the transaction module 230, the transaction module 230 may transfer the primary ownership of the asset and/or the digitized master asset to the third-party buyer. In an embodiment, transaction module 230 may transfer the digitized master asset and the master token from the digital wallet of the creator 112 to a digital wallet of the third-party buyer on the online transaction platform 125. The transaction module 230 may also store a timestamped record of the sales transaction in the digital ledger 155 and the master ledger respectively. The timestamped record may include encrypted metadata related to, but not limited to, primary ownership, the fractional segments, and the master token transferred.

In some embodiments, the processor 135 may also include a settlement module 235 to facilitate a distribution of proceeds from the sales transaction based on the primary ownership and the secondary ownership recorded by the registration module 210 and the fractional ownership module 225 respectively. The settlement module 235 may facilitate a distribution of proceeds based on mutual agreements between the creator 112 and the investors, such as, the investor 117. In an embodiment, the settlement module 235 may facilitate a distribution of proceeds based on the contract monetary value of cryptographic digital tokens transferred from the secondary ownership to the primary ownership respectively. The settlement module 235 may also store a timestamped record of the distribution of the proceeds in the digital ledger 155 and the master ledger respectively.

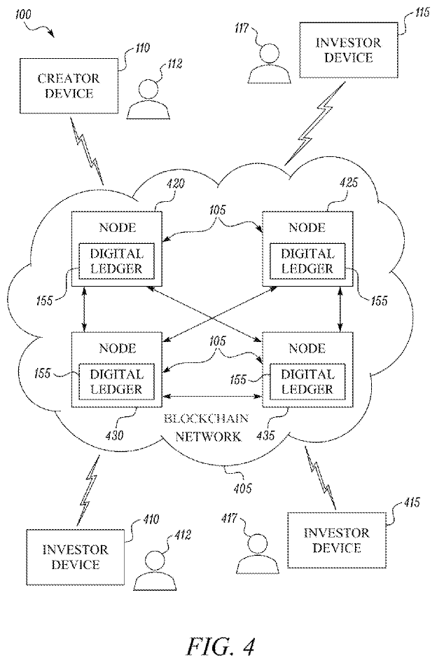

Referring to FIG. 4, the system 100 of FIG. 2 may also including multiple transaction servers 420-435, herein referred to as “nodes 420-435”, of the node 105 of FIG. 2. The nodes 420-435 may be interconnected with each other via multiple blockchain networks such as, a blockchain network 405. The system 100 may also include electronic devices, for example, the creator device 110 of the creator 112 and investor devices 115, 410, 415 of the investors 117, 412, 417, in communication with the nodes 420-435 via the blockchain networks such as, the blockchain network 405. The blockchain networks, such as the blockchain network 405 may include communication networks such as, but not limited to, a Local Area Network (LAN), a Wireless Local Area Network (WLAN), a Wide Area Network (WAN), internet and a Small Area Network (SAN). The blockchain networks may correspond to, but not limited to, public blockchain networks, private blockchain networks, hybrid blockchain networks, and/or federated blockchain networks. Examples of the blockchain networks include, but are not limited to, Ethereum, Bitcoin, Litecoin, Hyperledger Fabric, IBM Blockchain, OpenChain, Multichain, EOS, Hydrachain, Ripple, Stellar, R3 Corda, Quorum, Monero, Hyperledger Sawtooth, Neo, Hedera Hashgraph, Hyperledger Iroha and BigChainDB.

Further, the nodes 420-435 may include the digital ledger 155 respectively. In an embodiment, the nodes 420-435 may also provide the online transaction platform 125 to facilitate online transactions between the creator 112 and the investors 117, 412, 417. Further, the nodes 420-435 may also include the modules 205-235 (see FIG. 2) of the node 105 respectively and perform the functions of the modules 205-235 independently, as described with reference to FIG. 2. Accordingly, the timestamped records stored by the modules 205-235 in any of the nodes 420-435, for example, the node 420, may be simultaneously stored in the digital ledgers 155 of other nodes, for example, the nodes 425-435.

In some embodiments, a node, for example, the node 420, may share the encrypted timestamped records in with other nodes, for example, nodes 425-435, using the cryptographic keys and the numeric or alphanumeric hash values associated with the cryptographic keys. The encrypted timestamped records may be stored in the digital ledgers 155 simultaneously after a consensus between the nodes 420-435 is ascertained. The consensus may be ascertained by validating the numeric or alphanumeric hash values and cryptographic keys at the nodes 420-435 independently, verifying accuracy of the timestamped records, and aggregating responses at each node, for example, the node 420. The sharing and verification of the timestamped records at the nodes 420-435 respectively ensures privacy, security, accuracy, and validation of the timestamped records at the nodes 420-435. Accordingly, each digital ledger, for example, the digital ledger 155 of the node 420 may include similar and up-to-date timestamped records of the online transactions as the other digital ledgers, for example, the digital ledger 155 of the node 425-435 respectively at a specific point in time. Similarly, the master digital ledger generated by the fractional ownership module 225 of the 205-235 at a node, such as node 420, may also be simultaneously generated and updated at the other nodes 425-435.

### INDUSTRIAL APPLICABILITY

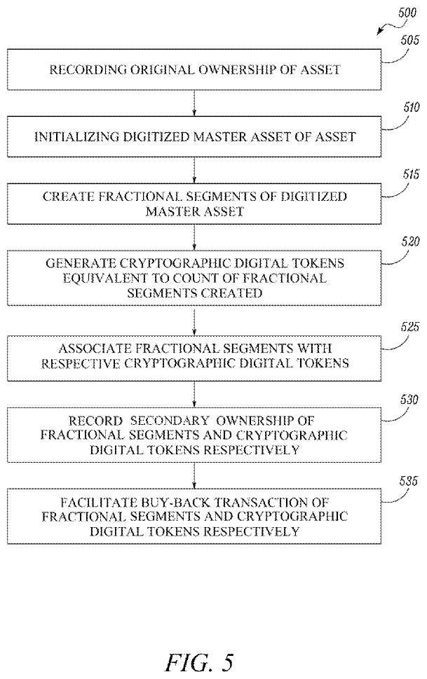

Referring to FIG. 5, a method 500 for monetization of fractional segments of an asset, such as, the artwork 300 of FIG. 3, is disclosed. The method 500 includes a step 505 of recording a primary ownership of the asset. The asset may be a tangible or an intangible asset. The method 500 may also include a step 510 of initializing a digitized master asset of the asset. Further, the method 500 may include a step 515 of creating multiple fractional segments of the digitized master asset. For example, the asset may be an artwork 300 (see FIG. 3) and the multiple fractional segments may correspond to multiple digitized visual portions 305 (see FIG. 3) of the artwork 300. The method 500 also includes a step 520 of generating multiple cryptographic digital tokens equivalent to a count of the plurality of fractional segments created. Furthermore, the method 500 includes a step 525 of associating the multiple fractional segments with respective cryptographic digital tokens generated. For example, the step 525 may correspond to associating the digitized visual portions 305 of the artwork 300 with the respective cryptographic digital tokens. In addition, the method 500 includes a step 530 of recording a secondary ownership of the multiple fractional segments and the associated cryptographic digital tokens respectively. The secondary ownership defines a monetary value of the associated cryptographic digital tokens respectively. The method 500 may also include a step (not shown) of storing a timestamped record of the primary ownership, the fractional segments created, the associated cryptographic digital tokens, and the secondary ownership in one or more digital ledgers, such as the digital ledger 155 (see FIGS. 1, 2, 4), of the node 105 or nodes 420-435. The timestamped record may include encrypted metadata related to the primary ownership, the plurality of fractional segments created, the associated cryptographic digital tokens, and the secondary ownership. The method 500 may also include a step (not shown) of generating a master digital ledger from the timestamped record. The master digital ledger may include encrypted metadata related to the primary ownership, the secondary ownership, the plurality of fractional segments and the associated cryptographic digital tokens. Further, the method 500 may include steps (not shown) of facilitating a change in the secondary ownership and storing the timestamped record of the change in the secondary ownership in the digital ledgers 155. The method 500 may also include a step 535 of facilitating a buy-back transaction of the plurality of fractional segments and the associated cryptographic digital tokens based on the primary ownership and the secondary ownership recorded. The method 500 may also include a step (not shown) of transferring ownership of the fractional segments and the associated cryptographic digital tokens from the secondary ownership to the primary ownership. Further, the method 500 may include a step (not shown) of storing the timestamped record of the ownership and the cryptographic digital tokens transferred in the digital ledgers 155. The method 500 may also include a step (not shown) of updating the master digital ledger from the timestamped records.

The method 500 may also include a step (not shown) of generating a master token from the cryptographic digital tokens transferred. The master token may have a monetary value equivalent to a sum of the monetary value of the cryptographic digital tokens respectively. Further, the method 500 may include a step (not shown) of storing the timestamped record of the master token generated in the digital ledgers 155. In addition, the method 500 may include a step (not shown) of facilitating a sales transaction of the digitized master asset and the master token to a third-party buyer. The sales transaction may correspond to a transfer of the primary ownership to the third-party buyer. The method 500 may also include a step (not shown) of facilitating distribution of proceeds from the sales transaction based on the primary ownership and the secondary ownership. Further, the method 500 may include a step (not shown) of storing the timestamped record of the sales transaction and the distribution of the proceeds in the digital ledgers 155.

### LIST OF ELEMENTS

100 system
105 transaction server/node
110 creator device
112 creator
115 investor device
117 investor
120 network
125 online transaction platform
130 bus
135 processor
140 memory
145 ROM
150 storage unit
155 digital ledger
160 display
165 input device
170 cursor control
175 communication interface
205 master asset module
210 registration module
215 initialization module
220 fractional segmentation module
225 fractional ownership module
230 transaction module
235 settlement module
300 artwork
305 visual portions
310 visual portion
315 visual portion
405 blockchain network
410 investor device
412 investor
415 investor device
417 investor
420 transaction server/node
425 transaction server/node
430 transaction server/node
435 transaction server/node

I claim:

1. A method for monetization of an asset, comprising:
recording a primary ownership of the asset, wherein the asset is a tangible or an intangible asset;
initializing a digitized master asset of the asset;
creating a plurality of fractional segments of the digitized master asset;
generating a plurality of cryptographic digital tokens equivalent to a count of the plurality of fractional segments created;
associating the plurality of fractional segments with the plurality of cryptographic digital tokens generated respectively;
recording a secondary ownership of the plurality of fractional segments and the associated cryptographic digital tokens respectively, wherein the secondary ownership defines a monetary value of the associated cryptographic digital tokens respectively; and
facilitating a buy-back transaction of the plurality of fractional segments and the associated cryptographic digital tokens based on the primary ownership and the secondary ownership recorded.

2. The method of claim 1, wherein the creating of the plurality of fractional segments is based on at least one of a visual segmentation, a semantic segmentation, or an electronic document segmentation of the digitized master asset.

3. The method of claim 1, wherein the associating of the plurality of fractional segments corresponds to associating a plurality of visual portions of the digitized master asset with the plurality of cryptographic digital tokens respectively, the digitized master asset including a digital image of an artwork.

4. The method of claim 1, comprising:
storing at least one timestamped record of the primary ownership, the plurality of fractional segments created, the associated cryptographic digital tokens, and the secondary ownership in one or more digital ledgers, wherein the at least one timestamped record includes encrypted metadata related to the primary ownership, the plurality of fractional segments created, the associated cryptographic digital tokens, and the secondary ownership; and
generating a master digital ledger from the at least one timestamped record, wherein the master digital ledger includes encrypted metadata related to the primary ownership, the secondary ownership, the plurality of fractional segments and the associated cryptographic digital tokens.

5. The method of claim 1, comprising:
facilitating a change in the secondary ownership; and
storing at least one timestamped record of the change in the secondary ownership in one or more digital ledgers.

6. The method of claim 1, wherein the facilitating of the buy-back transaction includes:
transferring the plurality of fractional segments and the associated cryptographic digital tokens from the secondary ownership to the primary ownership;
storing at least one timestamped record of the transferred cryptographic digital tokens in one or more digital ledgers; and
updating a master digital ledger based on the at least one timestamped record, wherein the master digital ledger includes encrypted metadata related to the primary ownership, the secondary ownership, the plurality of fractional segments and the transferred cryptographic digital tokens.

7. The method of claim 6, wherein the transferring includes:
generating a master token from the transferred cryptographic digital tokens, wherein the master token has a monetary value equivalent to a sum of the monetary value of the transferred cryptographic digital tokens respectively; and
storing at least one timestamped record of the master token generated in one or more digital ledgers.

8. The method of claim 7, comprising:
facilitating a sales transaction of the digitized master asset and the master token to a third-party buyer, wherein the sales transaction corresponds to a transfer of the primary ownership of the digitized master asset to the third-party buyer;
facilitating distribution of proceeds from the sales transaction based on the primary ownership and the secondary ownership; and
storing at least one timestamped record of the sales transaction and the distribution of the proceeds in one or more digital ledgers.

9. A system for monetization of an asset, comprising:
at least one transaction server including a digital ledger, wherein the at least one transaction server includes:
a communication bus;
a memory to store one or more predefined computer instructions; and
a processor coupled with the communication bus that is capable of executing the one or more predefined computer instructions in order to perform one or more functions, the one or more functions including:
recording a primary ownership of the asset, wherein the asset is a tangible or an intangible asset;
initializing a digitized master asset of the asset;
creating a plurality of fractional segments of the digitized master asset;
generating a plurality of cryptographic digital tokens equivalent to a count of the plurality of fractional segments created;
associating the plurality of fractional segments with the plurality of cryptographic digital tokens generated respectively;
recording a secondary ownership of the plurality of fractional segments and the associated cryptographic digital tokens respectively, wherein the secondary ownership defines a monetary value of the associated cryptographic digital tokens respectively; and
facilitating a buy-back transaction of the plurality of fractional segments and the associated cryptographic digital tokens based on the primary ownership and the secondary ownership recorded.

10. The system of claim 9, wherein the at least one transaction server corresponds to a plurality of transaction servers of the at least one transaction server interconnected via a network, the plurality of transaction servers including the digital ledger respectively.

11. One or more non-transitory computer-readable media comprising computer-executable instructions that, when executed, cause a computing system to perform a method for monetization of a tangible asset, the method comprising:
recording a primary ownership of the tangible asset;
initializing a digitized master asset of the tangible asset;
creating a plurality of fractional segments of the digitized master asset;
generating a plurality of cryptographic digital tokens equivalent to a count of the plurality of fractional segments created;
associating the plurality of fractional segments with the plurality of cryptographic digital tokens generated respectively;
recording a secondary ownership of the plurality of fractional segments and the associated cryptographic digital tokens respectively, wherein the secondary ownership defines a monetary value of the associated cryptographic digital tokens respectively; and
facilitating a buy-back transaction of the plurality of fractional segments and the associated cryptographic digital tokens based on the primary ownership and the secondary ownership recorded.
